(19) United States
(12) Patent Application Publication
(10) Pub. No.: US 2025/0299216 A1
(43) Pub. Date: Sep. 25, 2025

(54) STRATEGIC USE OF GAMES IN ECOMMERCE

(71) Applicant: 4D Holdings CA, LLC, Valley Village, CA (US)

(72) Inventors: Aaron Marshall, Valley Village, CA (US); Shawn Miller, Valley Village, CA (US)

(21) Appl. No.: 18/614,324

(22) Filed: Mar. 22, 2024

(51) Int. Cl. G06Q 30/0207

(52) U.S. Cl. CPC G06Q 30/0209; G06Q 30/0222

(57) ABSTRACT

This application is directed to methods of driving customer engagement on ecommerce platforms by using games as an incentive after a purchase. The inventive subject matter involves assigning tokens to a user who completes a purchase, granting the user access to a set of games, receiving a game selection, granting user entry to the game, and enabling the user to redeem the tokens to play the game. Embodiments also involve defining a prize pool structure and a prize distribution structure for each game and adjusting them based on the number of entrants. Some embodiments further involves using customer tracking and analytics tools, artificial intelligence, and social features to enhance the customer experience and loyalty.

### FIELD OF THE INVENTION

The field of the invention is improving customer engagement in ecommerce via gaming.

### BACKGROUND

The background description includes information that may be useful in understanding the present invention. It is not an admission that any of the information provided in this application is prior art or relevant to the presently claimed invention, or that any publication specifically or implicitly referenced is prior art.

E-commerce platforms typically allow customers to browse, select, and purchase products or services online. But once a customer completes a transaction, the interaction with the platform usually ends, resulting in low customer engagement and retention. Moreover, customers may experience post-purchase dissonance or regret, which can negatively affect their satisfaction and loyalty.

To address this problem, some e-commerce platforms have attempted to provide post-purchase incentives, such as discounts, coupons, or rewards, to encourage customers to revisit the platform or make additional purchases. But these incentives may not be sufficiently appealing or personalized to the customers and may also incur additional costs for the platform.

Therefore, there is a need for a novel and effective way of enhancing customer engagement and satisfaction after making a purchase on an e-commerce platform. One possible solution is to present games to the customers that are relevant to their purchase and preferences, and that can offer them entertainment, education, or social interaction. Such games can increase the perceived value and enjoyment of the purchase, reduce the likelihood of post-purchase dissonance, and motivate the customers to return to the platform or share their experience with others.

Thus, there is still a need in the art for a post-purchase game that a customer on an ecommerce platform can be invited to participate in and that can improve that customer's overall view of the ecommerce platform making them more likely to make additional purchases.

### SUMMARY OF THE INVENTION

The present invention provides systems and methods directed to using games to incentivize participation in ecommerce. In one aspect of the inventive subject matter, a method of driving customer engagement on an ecommerce platform is contemplated, the method comprising the steps of: after a user completes a purchase on the ecommerce platform, assigning, by a platform server, tokens to the user; granting the user access to a set of games; receiving a game selection; granting user entry to the game; and enabling the user to redeem the tokens to play the game.

In some embodiments, a quantity of the tokens is determined at least in part by how much money the user spent on the purchase. The game can be associated with a prize pool structure and a prize distribution structure, and the prize pool structure can include a prize pool size. Prize distribution structure can include a quantity of winners and prize distribution percents for each winner. In some embodiments, the method also includes the step of determining whether a number of entrants to the game exceeds a threshold.

In some embodiments, upon determining the number of entrants to the game exceeds the threshold, one or both of the prize pool structure and the prize distribution structure is adjusted. The method can also include the step of checking for open slots in a game before granting the user entry to the game.

In another aspect of the inventive subject matter, a method of driving customer engagement on an ecommerce platform is contemplated, the method comprising the steps of: after a user completes a purchase on the ecommerce platform, assigning, by a platform server, tokens to the user based on how much money the user spent on the purchase; granting, by the platform server, the user access to a set of games; receiving, by the platform server, a game selection; granting, by the platforms server, the user entry to the game; where the game is associated with a prize pool structure and a prize distribution structure; enabling, by the platform server, the user to redeem the tokens to play the game; determining, by the platform server, a set of winners of the game; calculating, by the platform server using the prize distribution structure and using the prize pool structure, winnings each winner of the set of winners should be awarded; and distributing the winnings to each winner.

In some embodiments, the prize pool structure comprises a prize pool size, and the prize distribution structure comprises a quantity of winners and prize distribution percents for each winner. The method can additionally include the step of determining whether a number of entrants to the game exceeds a threshold. Upon determining the number of entrants to the game exceeds the threshold, one or both of the prize pool structure and the prize distribution structure can be adjusted by the platform server. Methods can also include the step of checking for open slots in a game before granting the user entry to the game.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic showing how systems of the inventive subject matter are structured.

FIG. 2 is a flowchart describing how prize pool structures and prize distribution structures can be created and adjusted.

FIG. 3 is a flowchart describing the checkout process a user engages in with an ecommerce platform.

FIG. 4 is a flowchart describing how users can be presented with games that they can become an entrant to.

FIG. 5 is a flowchart describing how games can be operated.

FIG. 6 is a flowchart describing how games that have ended can be handled.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be noted that any language directed to a computer should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed system. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

Systems and methods of the inventive subject matter is directed to creating new way to engage customers through games that reward them after they make a purchase on an ecommerce platform. This feature is designed to motivate customers right after buying an item online by giving them a chance to play one or more games that can result in rewards including points, store credits, company cash, etc. Games can be instantly available or can be played later, depending on customer preferences.

Embodiments of the inventive subject matter are typically configured as shown in FIG. 1. Platform server 100 runs software that carries out tasks described as completed by the platform server in this application. Platform server 100 can be a single server computer, a set of server computers working together as one (e.g., a cloud), or any other arrangement of computers or server computers that allow users to interact with software running on the platform server 100 by accessing the platform server 100 via, e.g., personal computers 102. A platform server of the inventive subject matter can run both an ecommerce platform as well as run games of the inventive subject matter. In some embodiments, the term “platform server” may be understood as referring to different servers that run different services (e.g., one server or set of servers runs the ecommerce platform while a different server or set of servers runs the games) while nevertheless giving rise to a seamless user experience. Personal computers 102 are used by, e.g., users, where those users can become entrants to a game when they sign up to play after completing some transaction with an ecommerce platform. Three personal computers 102 are shown in the figure, and there is an ellipsis between the second and third to indicate the total number of users can be greater than three. FIG. 1 does not imply that multiple users must connect to platform server 100 simultaneously (e.g., one user can be connected at a time without deviating from the inventive subject matter).

Thus, individuals connecting to platform server 100 via personal computers 102 can be either users or entrants (e.g., they typically begin as users and become entrants once they choose to play a game), and software running on platform server 100 facilitates interactions between platform server 100 and personal computers 102 that give rise to embodiments of the inventive subject matter. Throughout this application, actions described as being performed by a user or entrant should be understood to refer to actions that a person takes via personal computer that causes the personal computer to relate that person's actions to platform server 100, where necessary. Similarly, actions described as being performed by a platform server should be understood to refer to actions or steps conducted via software running on the platform server along with any associated communications between the platform server and various personal computers, etc.

In addition to personal computers 102, an administration computer 104 is shown. Administration computer 104 can be any type of computer that allows for a system administrator to access platform server 100 to make backend, or administrative, changes to the way software on the platform server operates. For example, a person or people that have access to the administrating computer 104 can be individuals responsible for organizing a game of the inventive subject matter. Administrating computer 104 can facilitate adjustments to any parameters described in this application that relate to the platform server or software that is run on the platform server. A system administrator that uses administrating computer 104 can therefore, e.g., define, change, and otherwise act as an administrator regarding all variables described in this application, including prize pool structure, prize distribution structure, entrant thresholds, and so on.

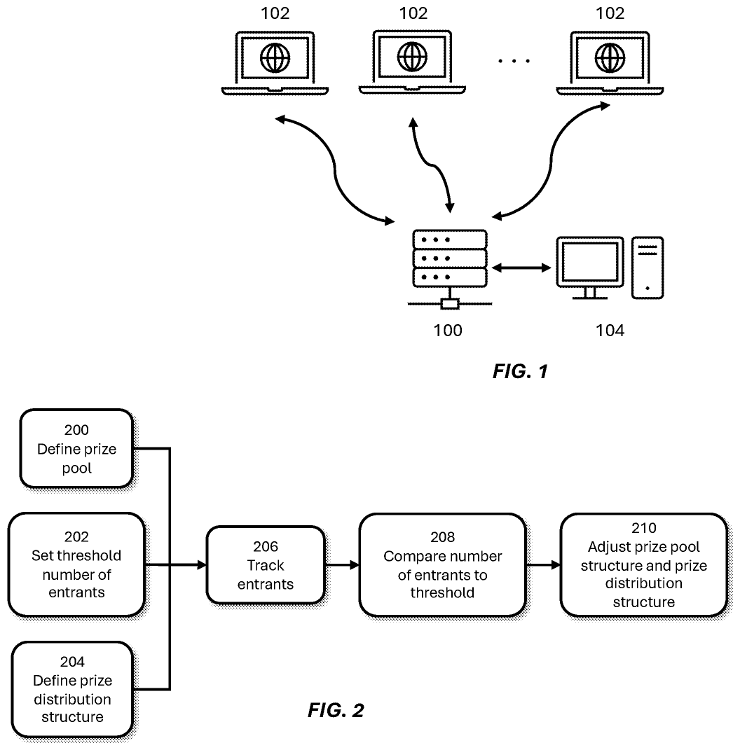

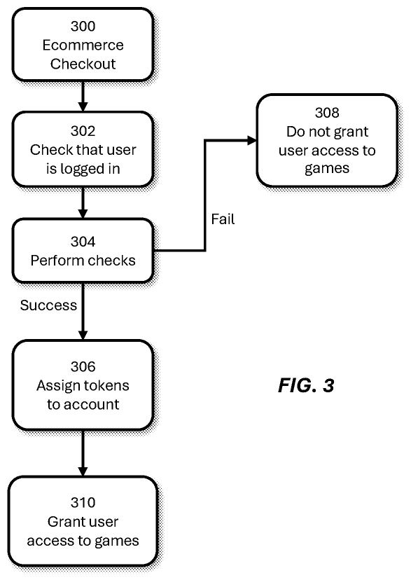

FIG. 2 is a flowchart that describes how prize pools are structured and how prizes are distributed. In step 200, a prize pool structure is defined. This can be done, e.g., by a system administrator selecting a predefined prize pool structure or by a system administrator developing a custom prize structure. A prize pool structure comprises, for example, the type of prize (cash, reward points, credit, or the like) as well as a prize pool amount (e.g., how much is in the prize pool). In some embodiments, a prize pool structure can include out parameters that define a rolling prize pool. Rolling prize pools are prize pools that grow according to a number of entries into a game, allowing prize pools to grow beyond the magnitudes of prize pools that feature fixed incentives.

By integrating with, e.g., existing loyalty programs, customers can earn rewards through their participation in games, bridging a gap between single purchases and continued engagement. Rewards earned by playing games of the inventive subject matter can include cash, reward points (e.g., loyalty program points), discount coupons, free products, exclusive offers, store credits, rebates, coupons, and so on. Customers can track their rewards and view upcoming game-related incentives via, e.g., their customer account with a particular ecommerce platform, which can be stored on or accessible to the platform server.

In step 202, a threshold number of entrants can be defined. This threshold number can be based on, e.g., an optimal number of participants for a game, a total number of expected participants, a mathematical expression, or defined on an ad hoc basis by a system administrator. The threshold comprises a number of entrants that, when exceeded, results in adjustments being made to a prize pool structure, a prize distribution structure, or both.

In step 204, a prize distribution structure is defined. A prize distribution structure can be based on one or any combination of, e.g., an expected number of entrants, a threshold number of entrants, a prize pool size, and so on. Prize distribution structures can define a number of parameters relating to prize distribution, including how many entrants can win a game, prize percentages for each winning entrant, and so forth. Prize amounts paid can thus be based on the number of entrants and the total prize pool.

The following discussion is directed to an example of how a prize pool structure and prize distribution structure can be defined. One aspect of a prize pool structure is a magnitude of the prize pool itself. And for any given prize pool, there will be some number of winners. In some embodiments, all entrants are winners, but it can also be the case that only some subset of entrants are winners. In such cases, a number of winners must be defined. This can be done mathematically, as described below.

For any given prize pool, a number of winning positions (N_{winners}) can be calculated, where N_{winners} defines the number of entrants that are considered winners of a given game. In some embodiments, N_{winners} can be defined by, e.g., a system administrator that sets a number N_{winners} that is less than or equal to a total number of entrants. Alternatively, a system administrator can select a pre-defined prize pool structure from a set of pre-defined prize pool structures, where, e.g., each pre-defined prize pool structure includes a value for N_{winners}. In embodiments where N_{winners} is mathematically defined, N_{winners} can be determined by multiplying a percent of entrants that are to be winners (P_{winners}) by a total number of entrants to a game (Nₑₙₜᵣₐₙₜₛ). Thus, the number of positions that should be paid (N_{winners}) is defined according to the equation below.

$${N}_{w i n n e r s} = {P}_{w i n n e r s} \times {N}_{e n t r a n t s}$$

For this equation to be useful in determining N_{winners}, values for both P_{winners} and Nₑₙₜᵣₐₙₜₛ are needed. As described above, P_{winners} can be a percent of total positions (e.g., 0-100%—in some games everyone should be a winner, even if the payout is very small, while in some games only a top percentage of entrants should be considered winners). Once N_{winners} has been calculated, individual payouts for winning entrants can be calculated.

An amount earned by each winning entrant can be expressed as a percent of a total prize pool (T_{prize}). In some embodiments, all percent values assigned to each winning entrant must add up to 100% (e.g., to account for the entire prize pool). In some embodiments, some amount of a prize pool may be withheld (i.e., all percent values assigned to each winning entrant adds up to less than 100%), e.g., to account for taxes, create an initial pool for a subsequent game, etc. Prize percents for each individual winner (P_{indwinner}) can be apportioned on a custom basis. For example, all winning positions can be given the same percent of a prize pool in some embodiments, while in other embodiments, top winners may be awarded a higher precent of a prize pool than lower winners. Prize percentages can be created according to a mathematical expression or manually defined.

Once all prize percentages for all winning entrants have been defined, individual prize amounts (A_{indwinner}) for each position can thus computed by multiplying P_{indwinner} by T_{prize} and dividing by 100. Individual prize amounts for each position can be calculated this way.

$${A}_{indwinner} = {P}_{indwinner} \times {T}_{prize}$$

To calculate all individual winner amounts together, A_{indwinner} can be an array, P_{indwinner} can be an array, and T_{prize} can be a scalar value. Otherwise, if A_{indwinner} is a scalar value associated with a specific winning entrant-say, the 8th winner-then P_{indwinner} would similarly be a scalar value corresponding to the percent of the prize pool that should go to the 8th winner.

For example, take a game with 100 entrants and a T_{prize} of $10,000, where the game pays out the top 15% of participants (i.e., P_{winners} is 15%) according to a progressive payout schedule (each value of P_{indwinner} varies according to each winning entrant's performance). First, given there are 100 total entries, the number of entries that should be paid out is 15.

$${N}_{w i n n e r s} = 15 \% \times 100 = 15$$

To then determine how each winner is paid, a prize percentage list must be created for the 15 winners, where the prize percentage list includes P_{indwinner} for each winning entrant, according to win ranking (e.g., first place, second place, etc.). For example, a prize percentage list can include the percents listed in Table 1. Each of the values in the P_{indwinner} column can be used to create an array of P_{indwinner} values.

TABLE 1

| Rank | P_{indwinner} |
|---|---|
| 1 | 25% |
| 2 | 19% |
| 3 | 14% |
| 4 | 11% |
| 5 | 8% |
| 6 | 6% |
| 7 | 4% |
| 8 | 3% |
| 9 | 3% |
| 10 | 2% |
| 11 | 2% |
| 12 | 1% |
| 13 | 1% |
| 14 | 1% |
| 15 | 1% |

All the values of prize per winning entrant (P_{indwinner}) shown in Table 1 add up to 100%, resulting in a complete distribution of the prize pool. As mentioned above, some embodiments do not result in compete prize pool distribution and instead leave some remainder. According to Table 1, the entrant who finishes in first place would get 25% of the prize pool, second place would get 19%, and so on down the list. For a total prize pool of $10,000, that would mean the first-place entrant gets $2,500 (A_{indwinner} for the first-place entrant), the second-place entrant gets $1,900 (A_{indwinner} for the second-place entrant), and so on. Prize percents can be manually adjusted or set by a system administrator to create whatever prize distribution structure is desired or otherwise found to achieve a particular entity's goals in implementing an embodiment of the inventive subject matter. A number of entrants that are considered winners can thus be adjusted, the amount each winning entrant is awarded can be adjusted, and the total prize pool can be adjusted, among other parameters.

With a prize pool structure defined, a threshold entrant number defined, and a prize distribution structure defined, a game is ready for users to become entrants. Processes and methods relating to how users become entrants are described below in relation to FIGS. 3-6.

According to step 206, the platform server keeps track of how many entrants join a game. Before signing up, users can see all or some portion of a prize pool structure and a prize distribution structure of a game, which can act as an incentive to join the game. For example, a user may see how much money or rewards can be won in a game and decide to become an entrant into the game. In step 208, the platform server compares the number of entrants to the threshold number, and, if the number of entrants exceeds the threshold number, then the prize pool structure and the prize distribution structure can be adjusted in step 210.

Any variable relating to prize pool structure and prize distribution structure can be adjusted based on a threshold number of entrants being exceeded. For example, for every additional 10 entries beyond the threshold, one more paid position can be added and the prize percentages adjusted to increase the first place take (keeping in mind that prize percents for all positions cannot exceed 100%). The prize pool can also be increased accordingly so that the first-place entrant (and all other entrants) takes more than a situation with fewer entrants. In some embodiments, a gradual adjustment can be implemented. For example, for every 20 new entries beyond the threshold, three more paid positions can be added, prize percentages can be adjusted, and the prize pool can be increased. Although the examples above relate to a threshold being exceeded by 10 and 20 entrants, respectively, in some embodiments, each individual entrant over the threshold can result in adjustments to a prize distribution structure and to a prize pool structure.

Once prize pool structure and prize distribution structure changes are made per step 210, changes to one or both of the prize pool structure and the prize distribution structure can be communicated to entrants and potential entrants alike. This to increase both excitement and transparency for both groups of people. It is not a requirement that all information about prize distribution structure and prize pool structure be shown to entrants or would-be entrants, but it is generally preferable to disclose at least some information. Information can be used to generate excitement, provide useful information that may inform how users play a game, improve transparency, and so on.

FIGS. 3-6 are flowcharts describing how games of the inventive subject matter can be incorporated into ecommerce transactions in a way that incentivizes increased economic activity (e.g., purchasing transactions) with whatever ecommerce platform incorporates such games. FIG. 3 describes how a platform server of the inventive subject matter determines whether a user should be presented with a game.

Unlike traditional customer incentives that arise before purchase, systems and methods of the inventive subject matter connect with customers at a key point after completing a purchase, inviting customers to re-engage and build loyalty. This feature leverages increased customer interest after buying something to introduce a fun and rewarding activity that also motivates future purchases.

Thus, in step 300, a user completes a purchase via ecommerce platform by going through the platform's checkout process. The user has thus interacted with a platform server via personal computer. In some embodiments, the platform server runs both the ecommerce platform as well as games of the inventive subject matter that have been integrated into the ecommerce platform, though the platform server that handles games can be interacted with by an ecommerce platform via, e.g., API. In step 302, the platform server verifies that the user is logged in. Having an account with an ecommerce platform, for example, that a user completes a purchase with can be necessary in some embodiments. Because prizes must be distributed, requiring users to log in to an account can ensure that the platform server has any information it needs to ensure prizes can be distributed properly. Prize distribution can involve distributing money to a user's bank account (e.g., where bank information is information provided via a user account with an ecommerce platform), applying credit to a user's account with the ecommerce platform, awarding loyalty points, or any other type of prize pool distribution described in this application or otherwise possible according to any technical limitations of the inventive subject matter.

If in step 302 the platform server finds that a user is logged into an account, then the platform server conducts a series of checks in step 304. In some embodiments, the platform server checks how much a customer spent, a customer group, a customer tag, a minimum order amount required before a user can be allowed to play a game, a region, and so on. A customer group or tag can apply to certain customers. For example, some customers can belong to a custom group for regulatory reasons, jurisdictional reasons, and so on. Some customers can be tagged as ineligible for games (e.g., based on a ban, or for any reason deemed necessary by a system administrator). If a user has a custom tag indicating they exist in a jurisdiction that does not allow games of the inventive subject matter, for example, then that user may not be presented with game options on the basis of that custom tag.

If a user passes all or some subset of these checks, then the user can be assigned tokens according to step 306. In some embodiments, tokens of the inventive subject matter can be redeemed to take part in a game. For example, in a poker game, tokens can be chips. In other types of games, a user can redeem tokens for each round of a game they wish to play (e.g., one token is one life or one attempt at a game). If a user fails one or more of the checks, then the platform server can deny the user access to any games per step 308.

In some embodiments, the step of assigning tokens (306) can incorporate information gathered in step 304 where the platform server conducted checks. For example, an amount of tokens assigned to a user can depend on a customer tag, a group tag, how much the user has spent on the ecommerce platform in total, how much the user spent on a specific transaction, the user's region (e.g., the user must be in a region that allows the user to participate in games of the inventive subject matter), and so on. A platform server can check that the user has spent over a threshold sum of money (e.g., in total using that user's account), that the user has spent more than an order minimum on the current checkout transaction, that the user is in a region that allows the user to participate in games of the inventive subject matter, and so on. In some embodiments, a user can be assigned tokens based only on how much they spent in a purchasing transaction that took place in step 300.

Once a user has been assigned tokens in step 306, the platform server can grant the user access to available games per step 310. In some embodiments, the platform server can assign the user to group to view available games. For example, in some embodiments, entrants may fall into different purchase level categories depending on how much they spent. Users that spend between $1-$9.99, $10-$499.99, $500-$999.99, $1,000-$4999.99, $5,000-$9,999.99, and so on, in one transaction can be grouped, by the platform server, according to amount spent. In this example, if a user spends $5,500, the platform server can put them in a group only with other users that spend between $5,000 and $9,999.99, and users can then be awarded tokens based on an amount spent or based on the group they are assigned.

In this example, if a customer spends $5,500, the platform server can award that customer 5,000 tickets (whereas if the customer had spent $600, they would have been awarded 500 tokens). Grouping customers together according to spend can ensure that customers that spent very little are not in competition with customers that spent a lot more, and so certain games can restrict entrants according to their spending group. For example, it may not be desirable for a certain game to allow users who have only 5 tokens to play with users who have 5,000 tokens.

In another example, different customer segments can be grouped together. For example, customers having similar classes/tags can be grouped together and only allowed to play games with others having the same class/tag. For example, resellers are a class of customer, and in some games, resellers are only allowed to play with other resellers. Ecommerce customers are another class of customer can be subject to game restrictions—in some games, ecommerce customers are only allowed to compete with other ecommerce customers. The same can be true for region, among other classes/tags. Grouping entrants by classes/tags can allow for different games to have different prize pool structures and different prize distribution structures that, e.g., offer higher prize pools based on region, net profit margin, customer group, and so on. Thus, games that are available to a user can depend on the group they are assigned to, games that are currently running, or any of the factors used in step 304 to check whether a user should be granted access to games in the first place.

For the platform server to make games available to a user, the platform server must identify games that a user will be granted access to. In some embodiments, the platform server can select games for a user based on parameters such as customer group, spend limits, order value minimums, location information, jurisdiction of purchase, or any other parameter discussed in this application, and so on. These parameters can be considered, e.g., by a game selection algorithm. Games can also be presented according to hand selection by a system administrator. In other words, a system administrator can ensure that one or more games will always be presented to a user that has been granted access to games of the inventive subject matter. A system administrator may want to do this because some games are high performers, more popular, or some games are part of a paid promotion (e.g., a third party pays the ecommerce platform to promote a game). In this way, some combination of a system administrator and platform server software can customize what games are presented to each user. By customizing what games are presented to users based on these parameters, embodiments are able to maximize user engagement with an ecommerce platform by ensuring that games presented to a particular customer are suitable and interesting for that customer, thereby improving that customer's personalized experience.

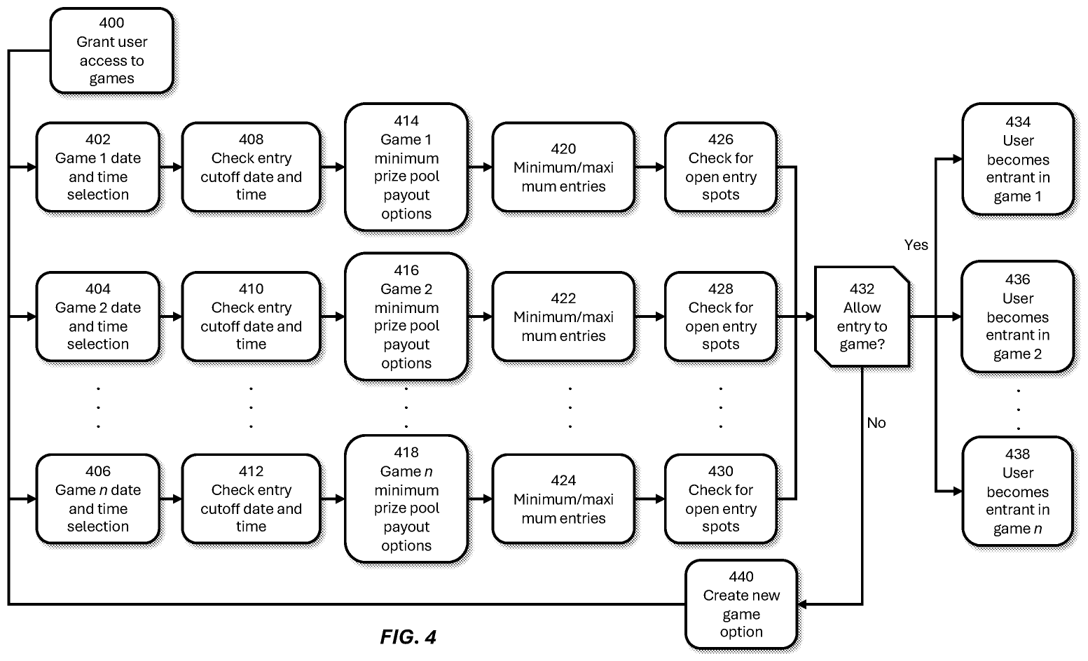

FIG. 4 is a flowchart describing how game selection takes place once a user has been granted access to games. The flowchart considers a situation where a user is granted access to play n number of games, where the flowchart shows game 1, game 2, and game n. This is intended to show that sets of games made accessible to a user can include any number of games. Although this example deals with n number of games, the set of games to which a user is granted access can include one or more games—there is no requirement that a user is granted access to more than one game.

Different games can have different game mechanics and different rules, and platform server can feature tools to create and customize games that can be accessed by a system administrator. Games are typically designed to incentive entrants to interact with a brand, website, ecommerce platform, or the like, especially after an entrant has completed a purchase. Game mechanics that can be implemented include point accumulation, level completion, and rewards that are tailored to align with business goals an ecommerce platform as well as with customer preferences.

Some embodiments of the inventive subject matter implement artificial intelligence to help tailor games and rewards to individual customers based on, e.g., information in their customer profiles, customer tracking information, customer analytics information, and so on. Customer profiles can include demographic information (age, location, gender, etc.), behavior information (hobbies, browsing habits, etc.), shopping information (e.g., customer tracking information including past purchases, items previously searched for, etc.), and so on. Taking these factors into account can help the platform server create a highly relevant and engaging experience for each user. In addition, game difficulty, rewards, and game content can be dynamically adjusted to suit different customer segments.

Thus, in step 400 a user is granted access to games. This step overlaps with step 310 from FIG. 3. If a user selects game 1, then the platform server in step 402 records a date and time that the game was selected. If the user selects either game 2 or game n, the same would occur in steps 404 and 406, respectively. Next, the platform server checks that the date and time the game was selected falls before an entry cutoff date and time in step 408. If the user selected game 1 after the cutoff, for example, they would not be able to enter the game. The same would be true for either of game 2 (step 410) or game n (step 412).

In step 414, the platform server retrieves minimum prize pool payout options for game 1. The same would occur in steps 410 and 412 for games 2 and n, respectively, if either of those games had been selected. For example, a platform server can, e.g., cap a game based on number of entrants or on spend threshold. Thus, a game could only allow customers with a minimum spend of $10,000. For example, total spend of 15 customer purchases that qualify for this group could be $150,000, and prize payout could be 3.333% (roughly $5,000). In this example, there would thus be a minimum of 15 entrants with a minimum prize pool of $5,000. To take this a step further the platform server can also inform an entrant that they have, e.g., 10,000 tickets that equates to a chance of winning that is 6.67% (10,000:150,000). This information can be motivating to some users, thereby improvement engagement. Notably, the prize pool can be increased depending on a number of entrants—the example above is included to help describe minimum prize pool payout options.

In step 420, the platform server retrieves minimum and maximum numbers of entries for game 1. Even though each game features includes a threshold value that can impact prize pool structure and prize distribution structure for a given game, each game can also have a minimum number of entrants and a maximum number of entrants. The threshold value can be less than the maximum number of entrants but greater than the minimum. Steps 422 and 424 describe the same for games 2 and n, respectively.

In step 426, the platform server checks if game 1 has any open slots. To determine if an open slot exists, the platform server can check whether the current number of entrants to a game is less than the maximum number of entrants allowed in the game. Steps 428 and 430 describe the same in relation to games 2 and n.

Finally, the platform server decides in step 432 whether a user can become an entrant in game. All information gathered and checks conducted in steps 402, 408, 414, 420, 426 can be considered before determining whether a user can become an entrant to game 1, and the same would be true for each of games 2 and n. For example, if a user selects game 1 before the cutoff time, the number of entrants to the game exceeds the minimum but is less than the maximum, and there are open spots in the game, then the user can become an entrant into game 1 in step 434. The same could be true for games 2 and n in steps 436 and 438, respectively.

When the platform server considers minimum and maximum numbers of entrants, in some embodiments, if the number of entrants is below the minimum, the game can be canceled and the entrants can be sent back to select a different game in step 432. In some embodiments, if a user attempts to enter a game but their entry to the game would cause the total number of entrants to exceed the maximum, the user would not be allowed to enter the game in step 432. In some embodiments, users can enter a game in excess of a maximum number of entrants, though every would-be entrant over the maximum at the game's start time would be denied entry into the game per step 432. This can be preferable because sometimes users may decide they do not want to play a game after indicating they want to but before the game begins. In such a case, that user would leave the game, which would free up space for entrants that would otherwise be disallowed entry because they would bring the game over the maximum to enter the game because the total number of would-be entrants has lowered in time for the game to begin. In other words, a number of open spaces can be evaluated at a time the game is set to begin, instead of computing open spaces on a continuous basis leading up to the game beginning. Steps 422 and 424 are the same and apply to games 2 and n, respectively.

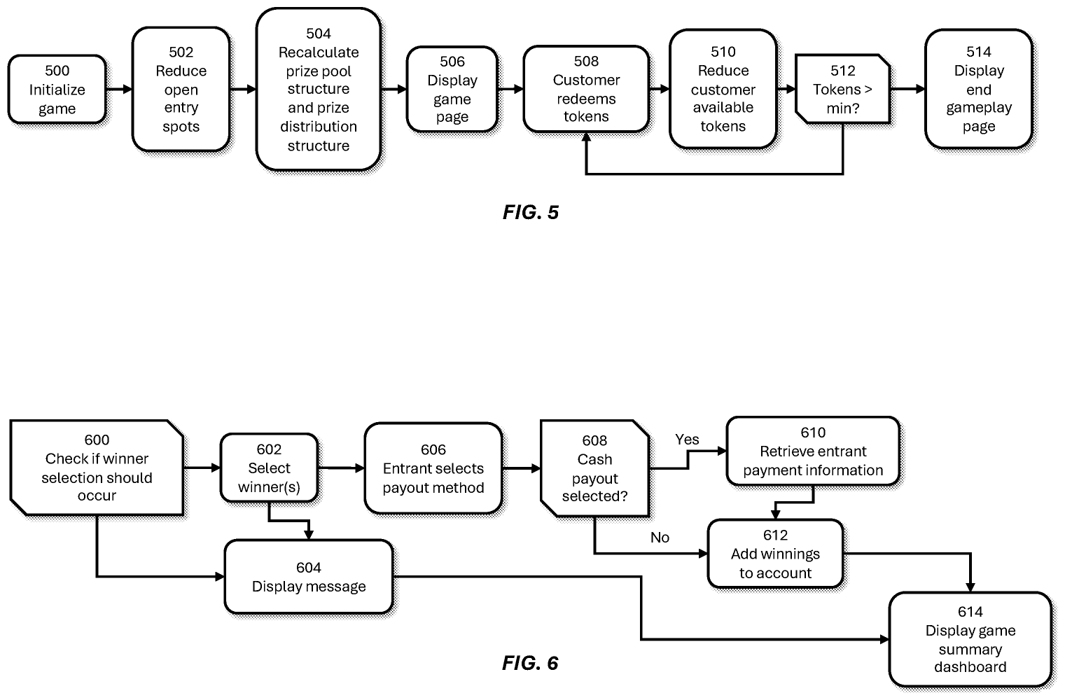

Once some number of users have selected the same game and become entrants into that game according to the flowchart in FIG. 4, the game can begin. FIG. 5 is a flowchart describing the process of beginning a game. In step 500, the platform server begins by initializing the game. Game initialization takes place over the course of steps 502 and 504, where in step 502 the number of open slots for the game is reduced and in step 504 the prize pool structure and the prize distribution structure are recalculated. In step 502, the number of open slots for a game can be reduced because, once a game is ready to begin, no more entrants should be added. By reducing the number of open entry slots to, e.g., zero, no entrants can be added after a game had begun. In some embodiments, the number of open entry slots can be reduced to a non-zero integer number that allows players to join even after a game has begun.

Prize pool structures and prize distribution structures are described above in more detail. In step 504, these structures can be recalculated based on new information relating to entrants in a game. For example, if the number of entrants in a game exceeds a threshold, then the prize pool structure and prize distribution structure may need to be recalculated according to how that game is configured to handle excess entrants beyond the threshold. This is also discussed above in more detail regarding step 210 in FIG. 2.

With the prize pool structure and prize distribution structure are recalculated in step 504, the platform server can then display a game page according to step 506. The game page allows an entrant to play a game. Games of the inventive subject matter can be played using, e.g., a web browser. To play a game, entrants can spend tokens they received in step 306, described above in relation to FIG. 3. Thus, according to step 508, an entrant can redeem tokens to play the game. Each time an entrant redeems tokens, their total number of tokens is reduced by the number of tokens the entrant redeemed in step 510, and then in step 512, the platform server checks whether the number of tokens that the entrant has is greater than a minimum allowable number of tokens. In some embodiments, a minimum allowable number of tokens is zero, and once an entrant reaches zero tokens, they can no longer play the game. In other embodiments, the minimum allowable number of tokens is greater than zero, which may be the case for a game that requires multiple tokens to play. Once the number of tokens an entrant has falls below that non-zero threshold value, the entrant can no longer play the game. In any event, if the entrant still has tokens, then the user can continue to redeem tokens in the game, repeating both steps 510 and 512 until they no longer have enough tokens to continue.

Once an entrant has redeemed enough tokens that the number of tokens they have left is below the minimum defined in step 512, the platform server then displays (e.g., causes the user's personal computer to display via web browser) an end gameplay page. The end gameplay page can include information relating to the end of the game, such as an announcement that the game has ended, some details about the game such as duration of time played, number of tokens redeemed, and information about when winners will be selected.

FIG. 6 is a flowchart that describes winner selection. The final condition of the flowchart in FIG. 5 relates to when an entrant is done playing a game, which may not coincide with a time that a game ends. In other words, just because one entrant can no longer play (e.g., due to insufficient tokens) does not mean a game must end, but once a game ends, the flowchart in FIG. 6 describes what happens next.

The platform server in step 600 first checks if winner selection should occur. In some embodiments, winner selection can occur when a game has ended, and a game can end based on a variety of factors. For example, a game can end when enough players have played the game, enough tokens have been redeemed across all entrants, and so on.

Thus, games can end upon satisfying a certain condition or conditions, and those conditions can vary from game to game. For example, slot machine games can end based on round outcomes, where a specific combination on a display might signify a win, potentially awarding the player with a standard prize, a grand prize, or both. In scenarios where no winning combination is achieved, the game concludes, and the grand prize is then increased. In the context of poker, a game can conclude when only a predetermined number of players remain, at which point all remaining players are awarded prizes and the game officially ends.

For games similar to Powerball, participants choose their numbers and either the game host draws numbers manually or a computer generates them. These types of games can conclude once winning numbers are announced. Players matching these numbers win; those who do not, lose. If there are no winners, the prize pool can be carried over to a subsequent game. In some embodiments, players can be automatically entered into subsequent games.

In some embodiments, winner selection can begin before a game has ended, as some games do not necessarily need to end. Winners can periodically be identified on a rolling basis in some games, and conditions leading to winner selection can be based on various criteria being met, such as reaching a certain number of tokens redeemed, a certain number of entrants with token quantities below the required threshold to continue playing, and so on.

As mentioned above, if a Powerball type game does not have any winners, the winnings can rollover into a subsequent game, thereby increasing the prize pool for that subsequent game to help attract new entrants. Thus, in some embodiments, games can introduce a progressively accumulating grand prize, where the prize carries over week by week if it remains unclaimed (e.g., there are no winners) by entrants, which enlarges potential winnings for future rounds.

In a slot machine example, where each round of play offers participants an opportunity to win both a regular prize and a grand prize, entrants could, therefore, win a regular prize without winning a grand prize, allowing the grand prize to continue growing until there is a winning entrant. Thus, in some games, some fraction of a regular prize pool can contribute to a grand prize as each round or game ends without a grand prize winner. For example, after each round of a particular game ends, 5% of a prize pool can be allocated to a grand prize pool, growing the size of the grand prize pool over time.

If winner selection occurs according to step 600, then in step 602, winners are selected. Winning criteria can vary from game to game, depending on the type of game, the winning conditions, etc. If, on the other hand, winner selection should not occur according to step 600 (e.g., because a game has not ended, or conditions that trigger winner selection have not been met), then the platform server can display a message to the entrant in step 604. The message can thank the entrant for taking part in the game. In some embodiments, the message can also give the entrant information about when and how a winner will be selected.

Moving back to step 602, when the platform server has determined that winners should be selected, the platform server then selects one or more winners. For entrants that are selected as winners, the platform server moves to step 606. For entrants that are not selected as winners, the platform server moves to step 604 and displays a message to those entrants as described above.

According to step 606, the platform server prompts winning entrants to select a payout method. To generalize, a payout method can be cash, points, credit, loyalty program credits, etc. If an entrant has selected a cash payout, then in step 610, the platform server can retrieve entrant payment information that can include account information for an account a user would like cash deposited to (e.g., a bank account, a payment service account like Venmo or Cash, and so on). In some embodiments, this information can be retrieved from an entrant's account where they previously stored such information. In instances where an entrant has not yet input any information indicating an account into which cash should be deposited, the platform server can prompt an entrant to input information to that effect.

Once the platform server has retrieved entrant payment information, the platform server in step 612 can add winnings to the winning entrant's account. In cases where an entrant has selected a cash payout, cash is deposited. In cases where a winning entrant did not select a cash payout, then, in step 612 the winnings can be added to a user's account in a form other than cash. In such a case, the winning entrant's account can be, e.g., an account with the ecommerce platform, an account that is associated with a user's preferred loyalty program, and so on. The amount of winnings added to a winning entrant's account is determined by the prize pool structure and the prize distribution structure for the game.

Once winnings have been added to a winning entrant's account, the platform server in step 614 displays a game summary dashboard to the winning entrant (e.g., via the winning entrant's personal computer). The game summary dashboard can feature information included an amount and type of winning that the entrant has been awarded and where it was deposited for the winning entrant.

Throughout various steps described above, the platform server can collect user information, and that user information can be used to improve games, improve engagement, improve user experience, improve advertising effectiveness, and so on. Thus, embodiments can leverage customer tracking and analytics tools. Complete customer tracking and analytics tools can help to provide insights into customer interactions, which enables constant improvement of game offerings and reward methods. Comprehensive tracking of customer interactions with games, including participation frequency, progress, and preferences can thus be implemented. Analytics tools can be used to evaluate effectiveness of games in terms of customer engagement and retention (e.g., how long did a user play, what aspects did the user engage with most, how much did a user progress through the game, etc.). In addition to tracking information and associated analytics, customer feedback can also be gathered and used to improve user experiences. For example, embodiments that leverage AI can use AI to analyze gameplay data to refine game design in a way that ensures games better align with customer expectations and interests. In addition to integrating with AI, embodiments can integrate with marketing and CRM tools to coordinate games with promotions and personalized marketing based on game insights.

Some embodiments of the inventive subject matter can additionally include social features. Systems and methods can encourage customers to share their game achievements or rewards on social media, which further enhances brand visibility and attracts new customers. Customers can also be encouraged within games to refer other customers.

Thus, specific systems and methods directed to improving customer engagement through strategic use of games integrated into ecommerce have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

1. A method of driving customer engagement on an ecommerce platform, the method comprising the steps of:
after a user completes a purchase on the ecommerce platform, comparing how much the user spent on the purchase to a minimum order amount required before the user can be allowed to play a game;
assigning, by a platform server, a token to the user;
granting the user access to a set of games based on how much the user spent;
receiving a game selection comprising the game;
granting the user entry to the game;
displaying, to the user via a web browser, a game page, wherein the user can redeem the token to play the game via the game page;
distributing winnings to each winner of the game;
determining whether the user has enough remaining tokens to play again; and
displaying, to the user via the web browser, an end gameplay page upon determining the user does not have enough remaining tokens to play again.

2. The method of claim 1, wherein a quantity of the tokens is determined at least in part by how much money the user spent on the purchase.

3. The method of claim 1, wherein the game is associated with a prize pool structure and a prize distribution structure.

4. The method of claim 3, wherein the prize pool structure comprises a prize pool size.

5. The method of claim 3, wherein the prize distribution structure comprises a quantity of winners and prize distribution percents for each winner.

6. The method of claim 3, further comprising the step of determining whether a number of entrants to the game exceeds a threshold.

7. The method of claim 6, wherein upon determining the number of entrants to the game exceeds the threshold, adjusting at least one of the prize pool structure and the prize distribution structure.

8. The method of claim 1, further comprising the step of checking for open slots in a game before granting the user entry to the game.

9. A method of driving customer engagement on an ecommerce platform, the method comprising the steps of:
after a user completes a purchase on the ecommerce platform, comparing how much the user spent on the purchase to a minimum order amount required before the user can be allowed to play a game;
assigning, by a platform server, tokens to the user based on how much money the user spent on the purchase;
granting, by the platform server, the user access to a set of games based on how much the user spent;
receiving, by the platform server, a game selection;
granting, by the platform server, the user entry to the game;
wherein the game is associated with a prize pool structure and a prize distribution structure;
displaying, to the user via a web browser, a game page, wherein the user can redeem the token to play the game via the game page;
determining whether the user has enough remaining tokens to play again;
displaying, to the user via the web browser, an end gameplay page upon determining the user does not have enough remaining tokens to play again;
determining, by the platform server, a set of winners of the game;
calculating, by the platform server using the prize distribution structure and using the prize pool structure, winnings each winner of the set of winners should be awarded; and
distributing the winnings to each winner.

10. The method of claim 9, wherein the prize pool structure comprises a prize pool size.

11. The method of claim 9, wherein the prize distribution structure comprises a quantity of winners and prize distribution percents for each winner.

12. The method of claim 9, further comprising the step of determining whether a number of entrants to the game exceeds a threshold.

13. The method of claim 12, wherein upon determining the number of entrants to the game exceeds the threshold, adjusting at least one of the prize pool structure and the prize distribution structure.

14. The method of claim 9, further comprising the step of checking for open slots in a game before granting the user entry to the game.
